(19) United States
(12) Patent Application Publication
(10) Pub. No.: US 2010/0165422 A1
(43) Pub. Date: Jul. 1, 2010

(54) Document Reading Apparatus

(75) Inventors: Kalmekolan Madan Mohan Reddy, Singapore (SG); Soon Keat Fah, Singapore (SG); Yeo Swee Heng, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/645,421

(22) Filed: Dec. 22, 2009

(30) Foreign Application Priority Data
Dec. 26, 2008 (JP) 2008-332896

(51) Int. Cl. H04N 1/04

(52) U.S. Cl. 358/474

(57) ABSTRACT

A document reading apparatus includes a housing, a module board including an imaging section disposed in the housing to read a document, and a module holder disposed in the housing to support the module board in a state in which a distance between the imaging section and the document is maintained at a predetermined value.

### BACKGROUND

1. Technical Field

The present invention relates to a document reading apparatus.

2. Related Art

According to the related art, a hand scanning document reading apparatus (e.g., a hand scanner, a mouse scanner or the like) is disclosed in JP-A-11-345074. In the hand scanning document reading apparatus, since the distance between an imaging section including a CCD or the like and a document to be read is needed to be maintained at a predetermined value, the imaging section is directly fixed to a housing by using a screw or the like.

However, the hand scanning document reading apparatus has been fabricated in a small size from the viewpoint of operability, and the imaging section may not be easily assembled into the housing.

### SUMMARY

An advantage of some aspects of the invention is to improve the assembling efficiency of an imaging section in a hand scanning document reading apparatus.

According to a first aspect of the invention, there is provided a document reading apparatus including: a housing; a module board including an imaging section disposed in the housing to read a document; and a module holder disposed in the housing to support the module board in a state in which a distance between the imaging section and the document is maintained at a predetermined value.

According to the document reading apparatus of the first aspect, the module holder, which supports the module board in the state in which the distance between the imaging section and the document is maintained at the predetermined value, is provided, so that the assembling efficiency of the imaging section can be improved.

In the document reading apparatuses according to the first aspect, the module holder may include a pedestal formed in a pedestal shape such that the imaging section is mounted thereon, and the imaging section may be supported by the pedestal. In such a case, the distance with respect to the document is maintained at the predetermined value by the pedestal, so that reading of the document can be facilitated.

In the document reading apparatuses according to the first aspect, the module board may have an external appearance of a rectangular shape and may have a shape adapted to a shape of the pedestal in a longitudinal direction thereof. In such a case, the module board can be firmly fixed to the module holder.

In the document reading apparatuses according to the first aspect, the module board may include a flap section having a shape corresponding to a shape of the pedestal, and the imaging section may be disposed at a front end of the flap section. In such a case, the imaging section is disposed at the front end of the flap section, so that the imaging section can be firmly fixed to the pedestal.

In the document reading apparatuses according to the first aspect, the pedestal may include a fixing section that fixes the flap section. In such a case, the flap section is fixed by the fixing section, so that the reading of the document can be facilitated.

The document reading apparatuses according to the first aspect may further include a position detection section that detects a position of the document reading apparatus. In such a case, the document reading apparatuses can also serve as a pointing device.

The document reading apparatuses according to the first aspect may further include a pressing section that presses the imaging section. In such a case, the imaging section reads the document in the state in which the imaging section is pressed by pressing section, so that the reading of the document can be facilitated.

In the document reading apparatuses according to the first aspect, the housing may include a lower housing member located at a lower portion thereof and an upper housing member disposed above the lower housing member, and the pressing section may be disposed on a surface of the upper housing member, which faces the lower housing member of the housing. In such a case, the pressing section is disposed on the upper housing member, so that the imaging section can be strongly pressed.

The invention can be realized in various shapes. For example, the invention can be realized as a copy machine, a facsimile machine or the like, which is provided at a part thereof with a hand scanner, in addition to the hand scanner and the mouse scanner.

### BRIEF DESCRIPTION OF THE DRAWINGS

The invention will be described with reference to the accompanying drawings, wherein like numbers reference like elements.

FIG. 1 is an exemplary view showing an external appearance of an upper side of a mouse scanner according to a first embodiment of the invention.

FIG. 2 is an exemplary view showing an external appearance of a lower side of a mouse scanner according to a first embodiment of the invention.

FIG. 3 is an exemplary view showing an internal configuration of a mouse scanner.

FIGS. 4A and 4B are exemplary views showing an external appearance of a module board.

FIG. 5 is an exemplary view showing an external appearance of a module holder and a LED module.

FIG. 6 is an exemplary view showing a part of an external appearance of a module holder.

FIG. 7 is an exemplary view showing a section of a module holder.

FIGS. 8A and 8B are exemplary views showing a shape of a slide section.

FIG. 9 is an exemplary view showing an external appearance of an opposite surface of a LED module.

FIGS. 10A to 10C are views showing the incorporation of an LED module into a module holder.

FIG. 11 is an exemplary view showing a section of a module holder in a state in which an LED module has been incorporated into a module holder.

FIG. 12 is an exemplary view showing an external appearance of an upper side of a module holder in a state in which an LED module has been incorporated into a module holder.

FIG. 13 is an exemplary view showing an external appearance of a lower side of a module holder in a state in which an LED module has been incorporated into a module holder.

FIG. 14 is an exemplary view showing a part of a section of a mouse scanner.

FIG. 15 is an exemplary view showing a section of a mouse scanner.

### DESCRIPTION OF EXEMPLARY EMBODIMENTS

Hereinafter, a document reading apparatus embodied as a mouse scanner according to embodiments of the invention will be described with reference to the accompanying drawings.

### A. First Embodiment

### A1. Configuration of Mouse Scanner

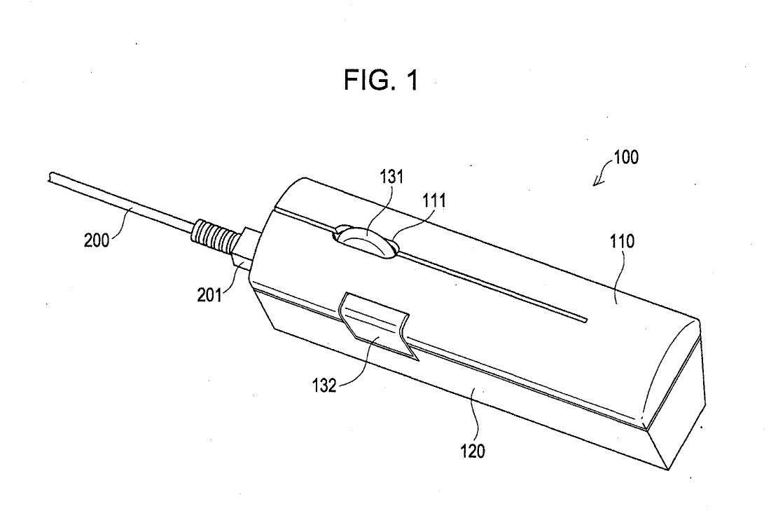

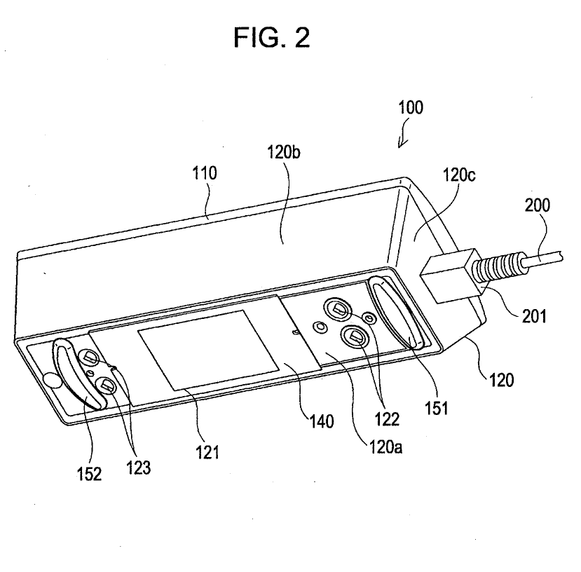

FIG. 1 is an exemplary view showing an external appearance of an upper side of the mouse scanner according to the first embodiment of the invention. FIG. 2 is an exemplary view showing an external appearance of a lower side of the mouse scanner according to the first embodiment of the invention. The mouse scanner 100 serves as a pointing device used for manipulation of a computer (not shown) in addition to an image reading apparatus, which optically reads an object (a document) to be read to output image data to the computer connected through a cable 200. The mouse scanner 100 is what is called a hand scanning type scanner, and reads the document by manually scanning the object (the document) to be read while making contact with the object. The mouse scanner 100 includes an upper housing member 110, a lower housing member 120, a wheel 131, a reading button 132, a transmission plate 140, a front foot section 151 and a rear foot section 152.

The upper housing member 110 is a cover member with an external appearance substantially of a long board shape and is disposed on the upper portion of the lower housing member 120. The upper housing member 110 and the lower housing member 120 form a housing of the mouse scanner 100. The upper housing member 110 is formed at the substantially center in the short side direction thereof with a wheel opening 111, so that a part of the wheel 131 disposed in the housing is exposed through the wheel opening 111.

The lower housing member 120 has a shape substantially that of a box with an upper opening and includes a bottom portion 120a having a substantially rectangular shape, lateral sides 120b formed at the long side thereof to be aligned adjacent to the bottom portion 120a, and lateral sides 120c formed at the short side thereof to be aligned adjacent to the bottom portion 120a. The lateral side 120c of the lower housing member 120 is formed with an opening through which a connector 201 is connected to the lower housing member 120. Hereinafter, according to the embodiment, a side of one of the lateral sides 120c formed with the opening so as to contact with the connector 201 will be referred to as a front side of the mouse scanner 100, and a side of the other one of the lateral sides 120c will be referred to as a rear side. In relation to the lower housing member 120, a document reading opening 121 having a rectangular shape is formed substantially in the center of the bottom portion 120a. Further, in relation to the lower housing member 120, front position detection openings 122 are formed between the front short side of the bottom portion 120a and the document reading opening 121, and rear position detection openings 123 are formed between the rear short side of the bottom portion 120a and the document reading opening 121.

The wheel 131 is used to perform scrolling or selection of an image displayed on a computer when the mouse scanner 100 is used as a pointing device. The reading button 132 is pressed when a scanning operation is performed by the mouse scanner 100. The transmission plate 140 is a flat plate having a substantially rectangular shape to cover the document reading opening 121. The transmission plate 140, for example, is formed using a transparent plastic plate or a glass plate.

Each of the front foot section 151 and the rear foot section 152 is a sliding member to reduce friction between the mouse scanner 100 and the document, and has a plane with a substantially oval shape and a trapezoidal section. For example, the front foot section 151 and the rear foot section 152 are made of plastic, urethane or the like. According to the embodiment, the front foot section 151 is disposed between the front short side of the bottom portion 120a and the front position detection openings 122, and the rear foot section 152 is disposed between the rear short side of the bottom portion 120a and the rear position detection openings 123.

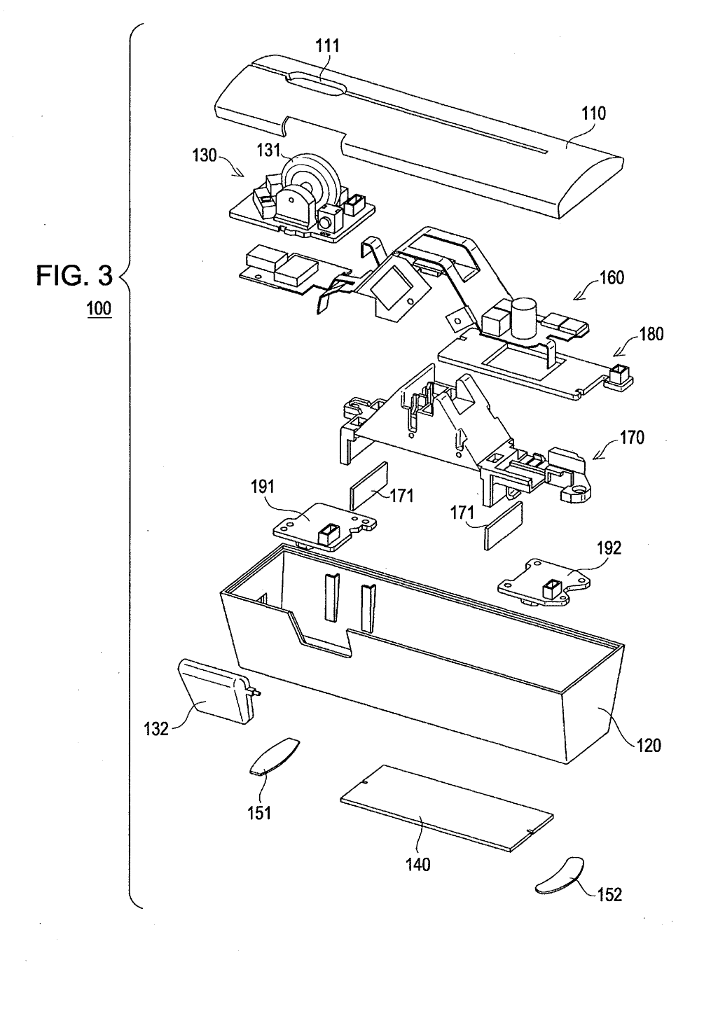

FIG. 3 is an exemplary view showing an internal configuration of the mouse scanner. The mouse scanner 100 has a detection unit 130, a module board 160, a module holder 170, an LED module 180, reflecting mirrors 171, a front position detection module 191 and a rear position detection module 192. Hereinafter, according to the embodiment, in the detection unit 130, the module board 160, the module holder 170, the LED module 180, the reflecting mirrors 171, the front position detection module 191 and the rear position detection module 192, a side facing the upper housing member 110 will be referred to as an upper side and a side facing the bottom portion 120a of the lower housing member 120 will be referred to as a lower side.

The detection unit 130 is connected to the wheel 131 to detect the rotational degree of the wheel 131 and converts the detected rotational degree into an electrical signal. Further, the detection unit 130 is connected to the reading button 132 to detect pressure applied to the reading button 132. In order to determine a relative position relation of a read image as the document reading apparatus, and a movement amount of a pointer as the pointing device, the front position detection module 191 and the rear position detection module 192 detect the position and direction of the mouse scanner 100 relative to a document, a mouse pad or the like.

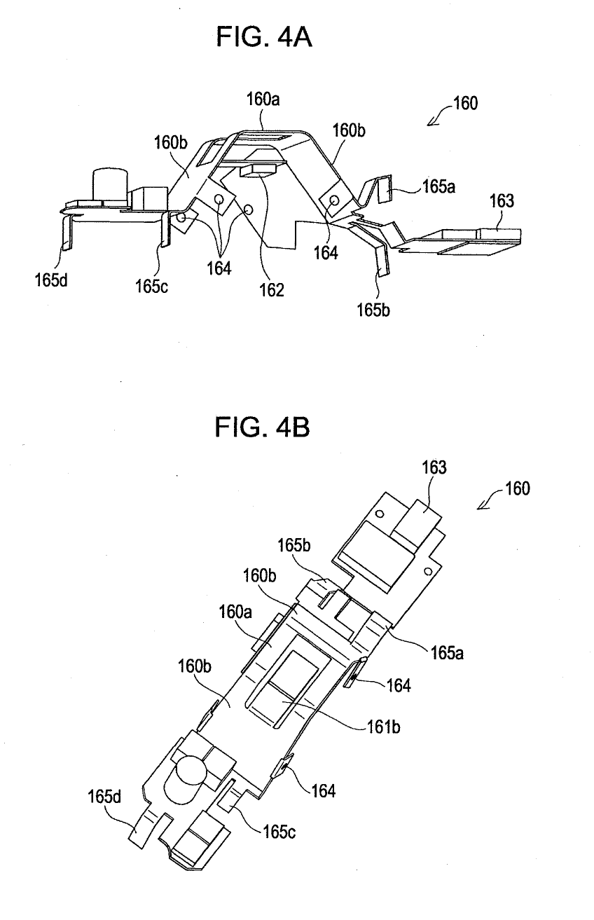

FIGS. 4A and 4B are exemplary views showing an external appearance of the module board. FIG. 4A is a side view showing the external appearance of the module board 160. The module board 160 is prepared in the form of an FPC (Flexible Printed Circuit) board including a center portion formed in a chevron shape and having a long board shape. The chevron shape has a flat top section 160a and inclined sections 160b formed at both sides of the top section 160a, and is formed to mate with the shape of a pedestal 172 of the module holder 170 which will be described later.

FIG. 4B is a top view showing the external appearance of the module board 160. The module board 160 includes a flap section 161b formed in a shape corresponding to the shape of the pedestal 172 of the module holder 170 which will be described later. According to the embodiment, the flap section 161b is formed by cutting a part of the top section 160a and the inclined section 160b in a U shape. The flap section 161b is bent at a base end formed at the inclined section 160b, and a front end thereof has a shape extending along the longitudinal direction of the module board 160.

The module board 160 includes an imaging section 162, a connecting section 163, a plurality of fixing holes 164 and a plurality of connecting end portions 165a to 165d. The imaging section 162, for example, is an image sensor called a CCD or CMOS imaging device, and receives reflected light of light irradiated onto the document to output an image signal corresponding to intensity of the received light. The imaging section 162 is disposed downward on the lower surface of a front end of the flap section 161b. The connecting section 163 is a socket to which the connector 201 of the cable 200 is connected. The fixing holes 164 are formed in a plurality of spots of the module board 160, and are used when the module board 160 is fixed to the module holder 170 which will be described later. The connecting end portions 165a to 165d are used when the detection unit 130, the LED module 180, the front position detection module 191 and the rear position detection module 192 are connected with the module board 160. In detail, the connecting end portion 165a is connected to a socket of the detection unit 130, the connecting end portion 165b is connected to a socket of the front position detection module 191, the connecting end portion 165c is connected to a socket of the LED module 180, and the connecting end portion 165d is connected to a socket of the rear position detection module 192.

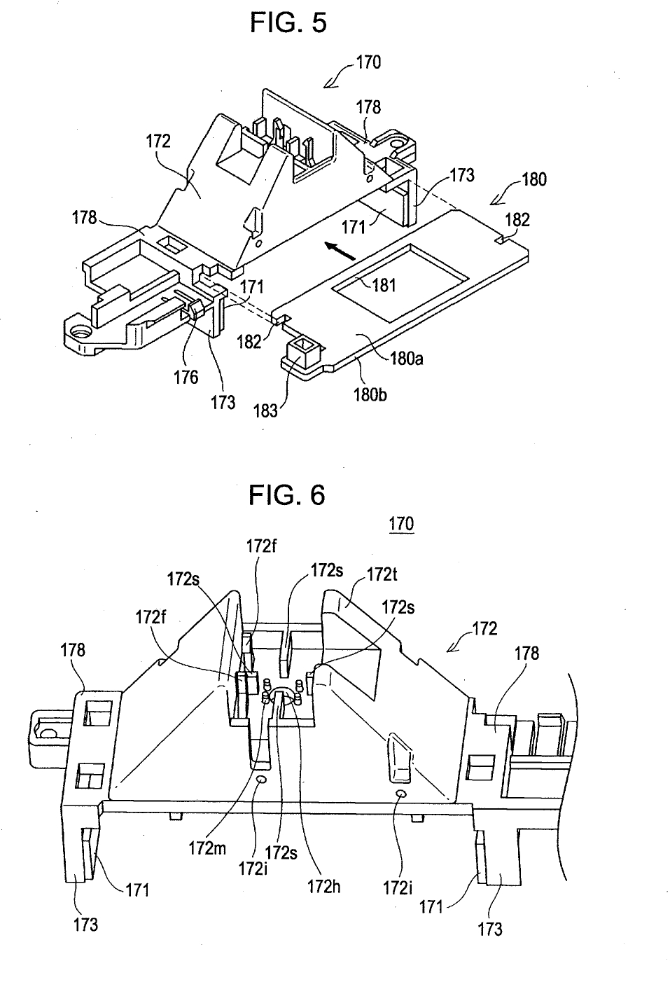

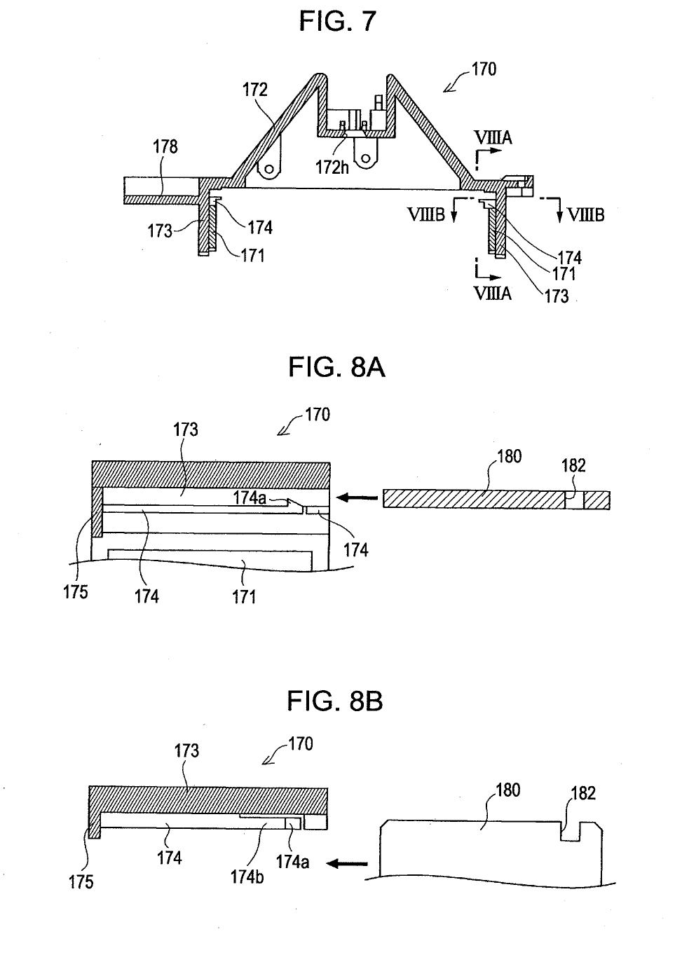

FIG. 5 is an exemplary view showing an external appearance of the module holder and the LED module. FIG. 6 is an exemplary view showing a part of the external appearance of the module holder. FIG. 7 is an exemplary view showing a section of the module holder. The module holder 170 is a support member for supporting the module board 160 and the LED module 180 which will be described later. For example, the module holder 170 is made of resin. The module holder 170 includes a hollow pedestal 172 having a substantially chevron sectional shape, a fixing section 178 formed at both sides of the pedestal 172 to fix the module holder 170 to the lower hosing member 120, and two legs 173 formed at a lower side of the pedestal 172 to allow the reflecting mirrors 171, which will be described later, to be disposed thereon.

As shown in FIG. 6, the pedestal 172 includes a hole 172h formed at the center of the upper portion thereof, a support section 172m for supporting the imaging section 162, a flap support section 172s for supporting the front end of the flap section 161b, a hook section 172f for fixing the front end of the flap section 161b, a concave section 172t for preventing movement of the rear end of the flap section 161b, and fixing holes 172i for fixing the module board 160. The flap support section 172s, the hook section 172f and the concave section 172t correspond to a fixing section according to the scope of the appended claims.

The legs 173 are formed in a substantially plate shape, and includes a base end portion connected to the fixing section 178 and a front end portion formed at the lower side of the base end portion. The two legs 173 are disposed such that main surfaces thereof face each other. The reflecting mirrors 171 are disposed on the main surfaces of the two legs 173, respectively.

The module holder 170 further includes slide sections 174 for supporting the LED module 180, and a locking section 176. The slide sections 174 are used for supporting the LED module 180 at the lower side of the pedestal 172. As shown in FIG. 7, the slide sections 174 are disposed at the base end portions of the legs 173, respectively. The locking section 176 is formed on the fixing section 178 to fix the LED module 180 supported at the lower side of the pedestal 172.

FIGS. 8A and 8B are exemplary views showing the shape of the slide section. FIG. 8A is a sectional view taken along line VIIIA-VIIIA of FIG. 7 and FIG. 8B is a sectional view taken along line VIIIB-VIIIB of FIG. 7. As shown in FIG. 8A, the slide section 174 extends on the main surface of the leg 173 along the direction (hereinafter, referred to as a transverse direction) perpendicular to the longitudinal direction of the module holder. The upper side of the slide section 174 is formed in a planar shape such that the LED module 180 can slide thereon. The slide section 174 includes a locking section 174a for locking the LED module 180. In order to allow movement in the top and bottom direction of the locking section 174a, the slide section 174 includes a movable section 174b which is not fixed to the leg 173, and the locking section 174a is formed at the end portion of the movable section 174b as shown in FIG. 8B. The module holder 170 is provided at the end thereof with a contact section 175 with which the LED module 180 sliding on the slide section 174 makes contact.

The LED module 180 is a substantially rectangular plate member and includes a main surface 180a having a surface and an opposite surface, and an end surface 180b. The main surface 180a is formed at the center thereof with an opening 181 having a rectangular shape. Further, as shown in FIG. 5, the LED module 180 is provided at the end portion of the surface in the longitudinal direction thereof with a socket 183.

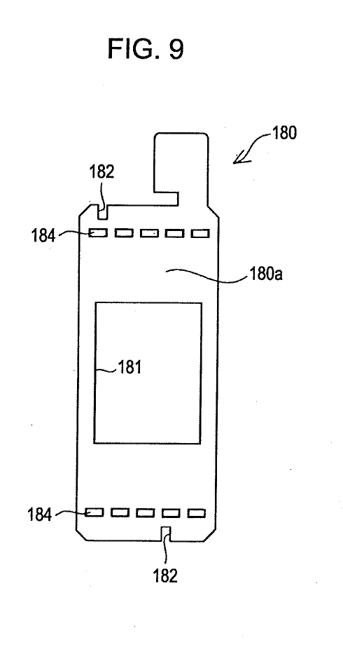

FIG. 9 is an exemplary view showing an external appearance of the opposite surface of the LED module 180. As shown in FIG. 9, the LED module 180 is provided at the end portions of the opposite surface in the longitudinal direction thereof with LEDs 184 disposed in a row along the short side thereof. The LED module 180 intermittently receives power from the module board 160 through the socket 183 to turn on/off the LEDs 184. Further, the LED module 180 is formed at a part of the short sides thereof with notch portions 182.

### A2. Incorporation Method of LED Module

The module holder 170 supports the LED module 180, which slides on the slide section 174 and is incorporated into the module holder 170, at the lower side of the pedestal 172. Hereinafter, an incorporation method of the LED module 180 into the module holder 170 will be described. As shown in FIG. 5, the LED module 180 is inserted between the facing main surfaces of the legs 173 in a state in which long sides of the LED module 180 are disposed in parallel to the module holder 170.

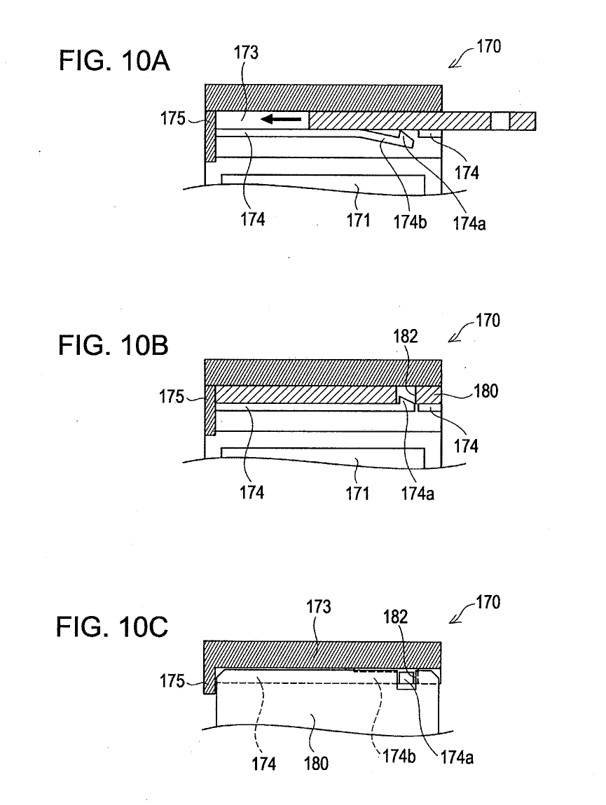

FIGS. 10A to 10C are views showing the incorporation of the LED module into the module holder. The LED module 180 is inserted between the lower side of the pedestal 172 and the slide surface of the slide section 174 and slides on the slide section 174. At this time, as shown in FIG. 10A, the locking section 174a makes contact with the LED module 180 and is depressed. Thus, the LED module 180 can slide on the slide section 174 although the locking section 174a is formed at the slide section 174. As shown in FIGS. 10B and 10C, if the LED module 180 slides on the slide section 174 and makes contact with the contact section 175, since the notch portion 182 of the LED module 180 is disposed above the locking section 174a, the locking section 174a moves upward to lock the LED module 180. Consequently, the LED module 180 is prevented from being moved in the direction opposite to the sliding direction. Further, the LED module 180 is prevented from being moved in the sliding direction by the contact section 175.

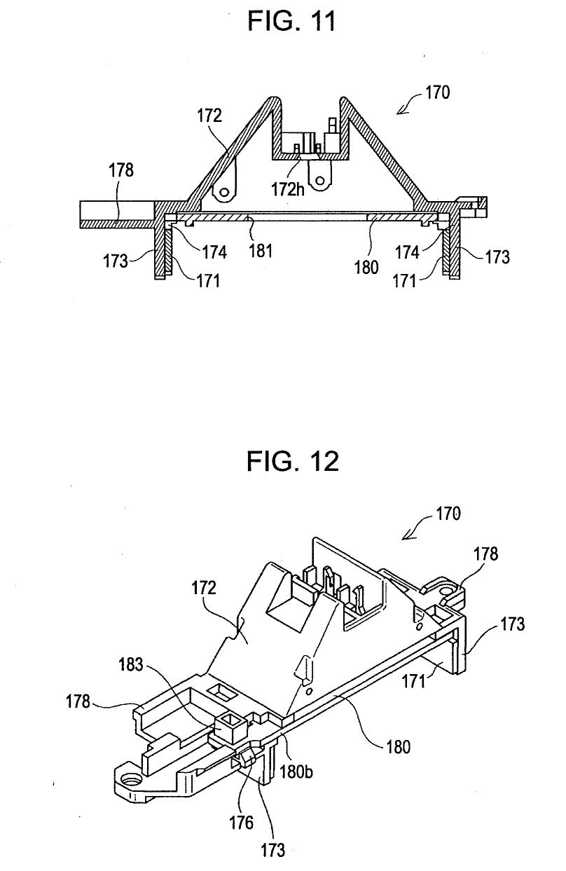

FIG. 11 is an exemplary view showing a section of the module holder in the state in which the LED module has been incorporated into the module holder. Since both ends of the LED module 180 in the longitudinal direction thereof are supported by the slide sections 174, the LED module 180 is prevented from being moved up and down. Further, the LED module 180 is prevented from being moved in the longitudinal direction by the legs 173. Thus, the LED module 180 incorporated into the module holder 170 is fixed at the position at which the opening 181 is located vertically directly below the hole 172h.

FIG. 12 is an exemplary view showing an external appearance of the upper side of the module holder in the state in which the LED module has been incorporated into the module holder. The module holder 170 is configured such that the socket 183 of the incorporated LED module 180 is disposed at the upper portion of the module holder 170 through the notch formed between the pedestal 172 and the leg 173. Further, the locking section 176 of the module holder 170 is locked with the end surface 180b of the incorporated LED module 180.

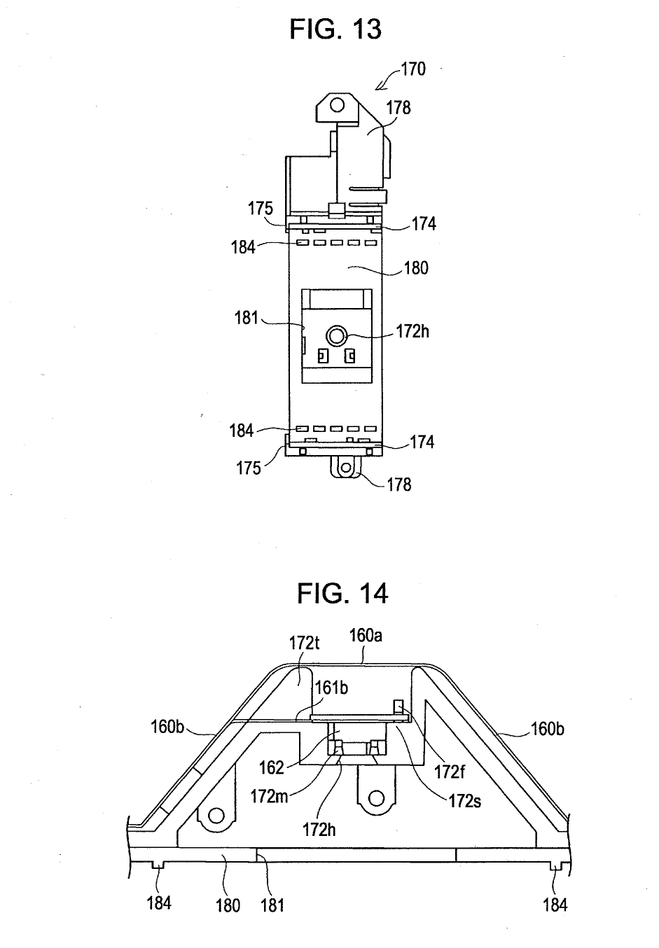

FIG. 13 is an exemplary view showing an external appearance of the lower side of the module holder in the state in which the LED module has been incorporated into the module holder. The LED module 180 incorporated into the module holder 170 is fixed at the position at which the hole 172h is located at the center of the opening 181 when seen in the bottom view.

### A3. Fixing Method of Module Board 160

FIG. 14 is an exemplary view showing a part of the section of the mouse scanner. The module board 160 is disposed on the module holder 170 in a state in which the chevron shape of the module board 160 is fitted into the pedestal 172 of the module holder 170. At this time, the imaging section 162 is supported by the support section 172m to receive light passing through the hole 172h. Further, the front end of the flap section 161b is prevented from being moved downward by the flap support section 172s and from being moved in the transverse and upward directions by the hook section 172f. In addition, the rear end of the flap section 161b is prevented from being moved in the transverse direction by the concave section 172t.

The fixing holes 172i of the module holder 170 are formed at positions corresponding to the fixing holes 164 of the module board 160. Thus, in the state in which the module board 160 is disposed on the module holder 170, plastic fixing pins (not shown) pass through the fixing holes communicating with each other, so that the module board 160 is fixed to the module holder 170.

### A4. Structure of Mouse Scanner

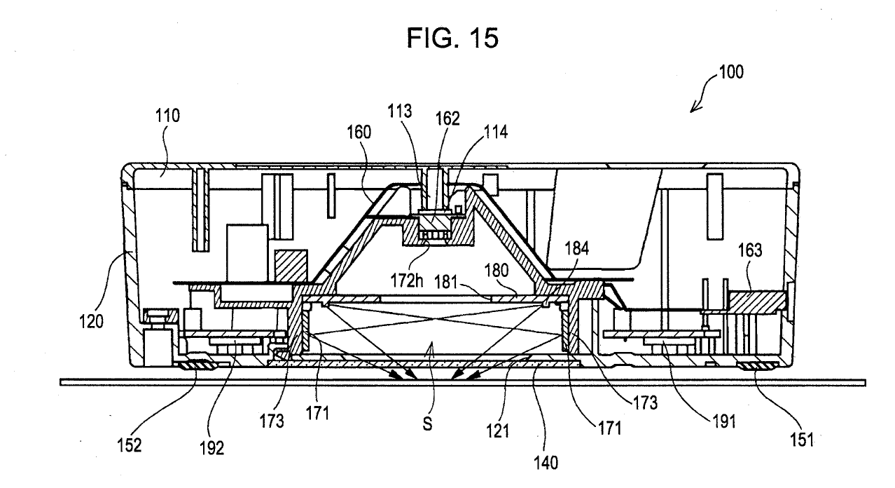

Hereinafter, the structure of the mouse scanner will be described in brief. FIG. 15 is an exemplary view showing the section of the mouse scanner. The module holder 170 straddles the document reading opening 121 using the legs 173 and is disposed in the lower housing member 120. According to the embodiment, the fixing section 178 of the module holder 170 is fixed to the lower housing member 120 by screws. However, the fixing method between the module holder 170 and the lower housing member 120 is not particularly limited. For example, they may be fixed to each other by screws or they may be fitted to each other by a fitting section having a convex-concave shape. The module holder 170 is fixed to the lower housing member 120, so that the imaging section 162 is fixed while maintaining the distance with respect to the document at a predetermined value in the mouse scanner 100.

As shown in FIG. 15, a downward protrusion 113 is formed on a surface of a lower side of the upper housing member 110. Thus, since the upper housing member 110 is disposed on the lower housing member 120, the protrusion 113 presses down the imaging section 162 via a cushion section 114, so that the imaging section 162 is strongly pressed toward the module holder 170. The protrusion 113 corresponds to a pressing section according to the scope of the appended claims. The protrusion 113 may be integrally formed with the upper housing member 110, or the protrusion 113 is formed separately from the upper housing member 110 and may then be attached to the upper housing member 110.

The mouse scanner 100 has a space S formed by the LED module 180, the legs 173 and the bottom portion 120a. The LEDs 184 and the reflecting mirrors 171 are disposed in the space S. Thus, light projected from the LEDs 184 and light reflected from the reflecting mirrors 171 can be irradiated onto the document with uniform distribution.

According to the above structure, a part of the light projected from the LEDs 184 is reflected from the reflecting mirrors 171, and a remaining part of the light projected from the LEDs 184 is directly irradiated onto the document through the document reading opening 121. Reflected light of the light irradiated onto the document is detected by the imaging section 162 through the document reading opening 121, the opening 181 and the hole 172h.

According to the mouse scanner 100 of the first embodiment as described above, the module holder 170, which supports the module board 160 in the state in which the distance between the imaging section 162 and the document is maintained at the predetermined value, is provided, so that the assembling efficiency of the imaging section 162 can be improved. In detail, according to the related art, the imaging section 162 is directly fixed to the housing, but the imaging section 162 may not easily be directly assembled into the housing due to the shape of the apparatus or the like. However, according to the invention, by the module holder 170, the module board 160 including the imaging section 162 can be assembled into the module holder 170. Further, the module holder 170 is fixed to the housing, so that the imaging section 162 can be easily fixed to the housing. In addition, the distance between the imaging section 162 and the document can be maintained at the predetermined value by the module holder 170.

According to the mouse scanner 100 of the first embodiment, the module holder 170 includes the pedestal 172 for receiving the imaging section 162, and the imaging section 162 reads the document via the pedestal 172, so that reading of the document can be facilitated. In detail, the pedestal 172 is provided on the upper portion thereof with the support section 172m, the flap support section 172s, the hook section 172f and the concave section 172t, so that the imaging section 162 and the module board 160 can be firmly fixed, and separation or vibration of the imaging section 162 can be prevented. Further, the pedestal 172 has the external appearance of the chevron shape and is formed in a hollow shape, and the imaging section 162 faces the document from the hole 172h of the pedestal 172 via the hollow portion, so that the distance between the imaging section 162 and the document can be maintained at the predetermined value by the hollow portion, and the reading of the document can be facilitated.

According to the mouse scanner 100 of the first embodiment, the module board 160 has the external appearance of a long board shape and has a shape adapted to the shape of the pedestal 172 of the module holder 170 on the basis of the longitudinal direction of the module board 160, so that the module board 160 can be firmly fixed to the module holder 170. In detail, the chevron shape of the module board 160 mates with the shape of the pedestal 172 of the module holder 170, so that the module board 160 can be prevented from being moved in the longitudinal direction thereof.

According to the mouse scanner 100 of the first embodiment, the imaging section 162 is disposed at the front end of the flap section 161b, so that the imaging section 162 can be firmly fixed to the pedestal 172. In detail, since the flap section 161b has a shape corresponding to the shape of the pedestal 172, the imaging section 162 disposed at the front end of the flap section 161b is firmly fixed to the pedestal 172 by the flap support section 172s, the hook section 172f and the concave section 172t. Thus, although separation or vibration occurs in other elements of the module board 160, the imaging section 162 can be prevented from being influenced by the separation or vibration.

According to the mouse scanner 100 of the first embodiment, the pedestal 172 includes the fixing section for fixing the flap section 161b, so that the reading of the document can be facilitated. In detail, the front end of the flap section 161b is prevented from being moved downward by the flap support section 172s and from being moved in the transverse and upward directions by the hook section 172f. Further, the rear end of the flap section 161b is prevented from being moved in the transverse direction by the concave section 172t. Thus, the movement of the flap section 161b can be prevented and the separation or vibration of the imaging section 162 disposed at the front end of the flap section 161b can also be prevented.

According to the mouse scanner 100 of the first embodiment, the front position detection module 191 and the rear position detection module 192 are provided, so that the mouse scanner 100 can serve as a pointing device.

According to the mouse scanner 100 of the first embodiment, the downward protrusion 113 is formed on the surface of the lower side of the upper housing member 110, so that the reading of the document can be facilitated. In detail, the protrusion 113 presses down the imaging section 162, so the imaging section 162 is strongly pressed toward the module holder 170, so that the separation or vibration of the imaging section 162 can be prevented. Consequently, the imaging section 162 can read the document with high efficiency.

### B. Modified Example

The invention is not limited to the previous embodiment, and various modifications can be made within the scope of the appended claims. For example, the following modifications can be made.

### B1. First Modified Example

The mouse scanner 100 according to the first embodiment has the function of the pointing device. However, the mouse scanner 100 may be realized as a document reading apparatus having only the scanning function. Even in such a case, the module holder 170 is provided, so that the assembling efficiency of the imaging section 162 can be improved.

### B2. Second Modified Example

In the mouse scanner 100 according to the first embodiment, the imaging section 162 is pressed by the protrusion 113 formed on the upper housing member 110. However, the pressing section for pressing the imaging section 162 is not limited to the member formed on the upper housing member 110. For example, a plate-shaped pressing member provided at the upper portion of the imaging section 162 is fixed to the lower housing member 120 by a screw or the like, so that the imaging section 162 may be pressed. Even in such a case, the separation or vibration of the imaging section 162 can be prevented and the imaging section 162 can read the document with high efficiency. Further, the mouse scanner 100 according to the invention can be realized without the protrusion 113 and the pressing section.

### B3. Third Modified Example

In the mouse scanner 100 according to the first embodiment, the pedestal 172 having the external appearance of the chevron shape while being formed in the hollow shape is provided such that the imaging section 162 is disposed thereon. However, the pedestal 172 may have various shapes if the distance between the imaging section 162 and the document can be maintained at the predetermined value. For example, a section supporting the imaging section 162 may be formed in a cylindrical shape, a circular column shape or the like. Further, the imaging section 162 may be supported by a plurality of legs.

### B4. Fourth Modified Example

In the mouse scanner 100 according to the first embodiment, the flap section 161b is formed by partially cutting the module board 160 in the U shape. However, the flap section 161b may have various shapes without being limited to the U shape if a shape corresponding to the shape of the pedestal 172 of the module holder 170 exists. For example, only the front end on which the imaging section 162 is disposed may be widened, or a shape mating with the shape of the fixing section of the pedestal 172 may be employed.

### B5. Fifth Modified Example

The housing of the mouse scanner 100 according to the first embodiment is formed by the upper housing member 110 having the external appearance substantially of the long board shape and the lower housing member 120 having the shape substantially that of the box with the upper opening and including the bottom portion 120a having the substantially rectangular shape. However, the shape of the housing is not particularly limited thereto, and the housing may have various shapes. For example, the housing may have a plane of an oval shape and may have a section of a chevron shape. Further, the lower housing member 120 may serve as a lower cover.

### B6. Sixth Modified Example

In the housing of the mouse scanner 100 according to the first embodiment, the upper housing member is formed with the wheel opening 111 and the part of the wheel 131 protrudes. However, the wheel 131 may not be provided. Further, the reading button 132 is disposed at the later side of the mouse scanner 100. However, the reading button 132 may be disposed at various positions.

### B7. Seventh Modified Example

In the mouse scanner 100 according to the first embodiment, the slide section 174 extends on the main surface of the leg 173 along the transverse direction of the module holder 170. However, the slide section 174 may have various shapes if the LED module 180 has a slidable shape. For example, the slide section 174 may be intermittently disposed in the transverse direction. Further, the locking section 174a may have various shapes other than the shape disclosed in the previous embodiment if the locking section 174a can fix the LED module 180 incorporated into the module holder 170. For example, the locking section 174a may be formed in a convex shape. Further, it may be that the movable section 174b is not provided.

### B8. Eighth Modified Example

The invention can be realized as a copy machine, a facsimile machine or the like, which is provided at a part thereof with a hand scanner, in addition to the hand scanner and the mouse scanner.

What is claimed is:

1. A document reading apparatus comprising:
a housing;
a module board including an imaging section disposed in the housing to read a document; and
a module holder disposed in the housing to support the module board in a state in which a distance between the imaging section and the document is maintained at a predetermined value.

2. The document reading apparatus according to claim 1, wherein the module holder includes a pedestal formed in a pedestal shape such that the imaging section is mounted thereon, and the imaging section is supported by the pedestal.

3. The document reading apparatus according to claim 2, wherein the module board has an external appearance of a rectangular shape and has a shape adapted to a shape of the pedestal in a longitudinal direction thereof.

4. The document reading apparatus according to claim 1, wherein the module board includes a flap section having a shape corresponding to a shape of the pedestal, and the imaging section is disposed at a front end of the flap section.

5. The document reading apparatus according to claim 4, wherein the pedestal includes a fixing section that fixes the flap section.

6. The document reading apparatus according to claim 1, further comprising a position detection section that detects a position of the document reading apparatus.

7. The document reading apparatus according to claim 1, further comprising a pressing section that presses the imaging section.

8. The document reading apparatus according to claim 7, wherein the housing includes a lower housing member located at a lower portion thereof and an upper housing member disposed above the lower housing member, and the pressing section is disposed on a surface of the upper housing member, which faces the lower housing member of the housing.
